(19) United States
(12) Patent Application Publication
(10) Pub. No.: US 2022/0083072 A1
(43) Pub. Date: Mar. 17, 2022

(54) WORK VEHICLE CONTROL SYSTEM AND WORK VEHICLE CONTROL METHOD

(71) Applicant: Komatsu Ltd., Tokyo (JP)

(72) Inventors: Shisato Yano, Tokyo (JP); Ryo Sakaki, Tokyo (JP)

(73) Assignee: Komatsu Ltd., Tokyo (JP)

(21) Appl. No.: 17/423,970

(22) PCT Filed: Jan. 20, 2020
(86) PCT No.: PCT/JP2020/001740

§ 371 Date: Jul. 19, 2021

(30) Foreign Application Priority Data
Feb. 1, 2019 (JP) 2019-017392

(51) Int. Cl. G05D 1/02; G01S 13/931; G01S 13/08; G01S 11/06

(52) U.S. Cl. CPC G05D 1/0238; G05D 1/0223; G05D 1/0257; G05D 2201/021; G01S 13/08; G01S 11/06; G01S 13/931

(57) ABSTRACT

The work vehicle control system includes a tracking unit that tracks a detection point of an object detected by an obstacle sensor in a course area through which a work vehicle passes and a tracking area outside the course area, and a traveling control unit that controls traveling of the work vehicle based on a tracking result of the detection point.

### FIELD

The present disclosure relates to a work vehicle control system and a work vehicle control method.

### BACKGROUND

At a work site such as a mine, a work vehicle such as a transport vehicle operates. If the work vehicle collides with an obstacle during traveling, the productivity at the work site may decrease. Therefore, an obstacle sensor for detecting an obstacle is mounted on the work vehicle, and when the obstacle sensor detects an obstacle, the traveling of the work vehicle is stopped.

### CITATION LIST

### Patent Literature

Patent Literature 1: International Publication No. 2015/025984

### SUMMARY

### Technical Problem

For example, if an obstacle is erroneously detected even though there is no obstacle due to insufficient detection accuracy of the obstacle sensor, the traveling of the work vehicle may be stopped unnecessarily. As a result, the productivity at the work site may decrease.

### Solution to Problem

According to an aspect of the present invention, a work vehicle control system comprises: a tracking unit that tracks a detection point of an object detected by an obstacle sensor in a course area through which a work vehicle passes and a tracking area outside the course area; and a traveling control unit that controls traveling of the work vehicle based on a tracking result of the detection point.

### Advantageous Effects of Invention

According to an aspect of the present invention, the decrease in productivity at the work site is suppressed.

### BRIEF DESCRIPTION OF DRAWINGS

FIG. 1 is a diagram schematically illustrating an example of a control system and a work vehicle according to an embodiment.

FIG. 2 is a diagram schematically illustrating an example of a work site according to an embodiment.

FIG. 3 is a diagram schematically illustrating an example of an obstacle sensor according to an embodiment.

FIG. 4 is a diagram schematically illustrating an example of a traveling course, a course area, and a tracking area according to an embodiment.

FIG. 5 is a diagram schematically illustrating an example of a traveling course, a course area, and a tracking area according to an embodiment.

FIG. 6 is a diagram schematically illustrating a course area, a tracking area, and a detection point of an object detected by an obstacle sensor according to an embodiment.

FIG. 7 is a functional block diagram illustrating an example of a management device and a control device according to an embodiment.

FIG. 8 is a diagram for explaining a tracking detection point according to an embodiment.

FIG. 9 is a diagram for explaining processing by a tracking unit according to an embodiment.

FIG. 10 is a diagram for explaining a stop condition according to an embodiment.

FIG. 11 is a flowchart illustrating an example of a control method of a work vehicle 2 according to an embodiment.

FIG. 12 is a block diagram illustrating an example of a computer system according to an embodiment.

### DESCRIPTION OF EMBODIMENTS

Hereinafter, embodiments according to the present disclosure will be described with reference to the drawings, but the present disclosure is not limited thereto. The components of the embodiments described below can be combined as appropriate. In addition, some components may not be used.

[Control System]

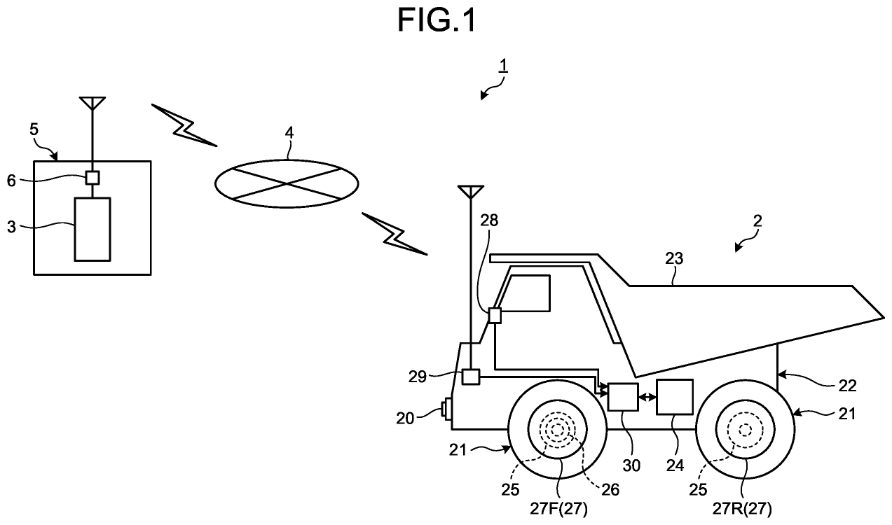

FIG. 1 is a diagram schematically illustrating an example of a control system 1 and a work vehicle 2 according to the embodiment. The work vehicle 2 operates at a work site. In the embodiment, the work vehicle 2 is an unmanned vehicle that operates unmanned without being driven by a driver. The work vehicle 2 is a dump truck, which is a type of transport vehicle that travels on the work site and transports cargo.

The control system 1 includes a management device 3 and a communication system 4. The control system includes a control system and a work vehicle 2. The management device 3 includes a computer system and is installed in, for example, a control facility 5 at a work site. The communication system 4 executes communication between the management device 3 and the work vehicle 2. A wireless communication device 6 is connected to the management device 3. The communication system 4 includes a wireless communication device 6. The management device 3 and the work vehicle 2 wirelessly communicate with each other via the communication system 4. The work vehicle 2 travels on the work site based on traveling course data transmitted from the management device 3.

[Work Vehicle]

The work vehicle 2 includes an obstacle sensor 20, a traveling device 21, a vehicle body 22 supported by the traveling device 21, a dump body 23 supported by the vehicle body 22, and a control device 30.

The obstacle sensor 20 detects an object around the work vehicle 2 in a non-contact manner. The obstacle sensor 20 detects an object in front of the work vehicle 2. The obstacle sensor 20 is arranged at a front portion of the vehicle body 22. The obstacle sensor 20 detects an object by irradiating the object with a detection wave. The obstacle sensor 20 has an emission unit that emits a detection wave and a receiving unit that receives the detection wave reflected by the object. The obstacle sensor 20 can detect a relative position with respect to the object. The relative position between the obstacle sensor 20 and the object includes one of the relative distance and the relative angle between the obstacle sensor 20 and the object.

Examples of the detection wave include radio waves, ultrasonic waves, and laser light. Examples of the obstacle sensor 20 include a radar device, an ultrasonic device, and a laser device. The radar device detects an object by emitting radio waves and receiving the radio waves reflected by the object. The ultrasonic device detects an object by emitting ultrasonic waves and receiving the ultrasonic waves reflected by the object. The laser device detects an object by emitting a laser beam and receiving the laser beam reflected by the object.

In the embodiment, it is assumed that the obstacle sensor 20 is a radar device (millimeter wave radar device).

The object detected by the obstacle sensor 20 includes an obstacle that exists in front of the work vehicle 2 and hinders the traveling of the work vehicle 2. Examples of obstacles include vehicles operating on the work site and natural objects such as rocks. Examples of the vehicle operating at the work site include an unmanned work vehicle different from the work vehicle 2 and a manned work vehicle that travels by the driving operation of the driver.

The traveling device 21 includes a drive device 24 that generates a driving force, a braking device 25 that generates a braking force, a steering device 26 that adjusts the traveling direction, and wheels 27.

As the wheels 27 rotate, the work vehicle 2 self-propels. The wheels 27 include front wheels 27F and rear wheels 27R. Tires are mounted on wheels 27.

The drive device 24 generates a driving force for accelerating the work vehicle 2. The drive device 24 includes an internal combustion engine such as a diesel engine. Note that the drive device 24 may include an electric motor. The power generated by the drive device 24 is transmitted to the rear wheels 27R. The braking device 25 generates a braking force for decelerating or stopping the work vehicle 2. The steering device 26 can adjust the traveling direction of the work vehicle 2. The traveling direction of the work vehicle 2 includes the direction of the front portion of the vehicle body 22. The steering device 26 adjusts the traveling direction of the work vehicle 2 by steering the front wheels 27F.

The control device 30 outputs an accelerator command for controlling the drive device 24, a brake command for controlling the braking device 25, and a steering command for controlling the steering device 26.

The drive device 24 generates a driving force for accelerating the work vehicle 2 based on the accelerator command output from the control device 30. The braking device 25 generates a braking force for decelerating the work vehicle 2 based on the brake command output from the control device 30. By controlling one or both of the drive device 24 and the braking device 25, the traveling speed of the work vehicle 2 is adjusted. The steering device 26 generates a steering force for changing the direction of the front wheels 27F in order to move the work vehicle 2 straight or turn it based on the steering command output from the control device 30.

Further, the work vehicle 2 includes a position detection device 28 that detects the position of the work vehicle 2. The position of the work vehicle 2 is detected using the Global Navigation Satellite System (GNSS). The global navigation satellite system includes a Global Positioning System (GPS). The global navigation satellite system detects the absolute position of the work vehicle 2 defined by the coordinate data of latitude, longitude, and altitude. The global navigation satellite system detects the position of the work vehicle 2 as defined in a global coordinate system. The global coordinate system is a coordinate system fixed to the earth. The position detection device 28 includes a GNSS receiver and detects the absolute position (coordinates) of the work vehicle 2.

Further, the work vehicle 2 includes a wireless communication device 29. The communication system 4 includes a wireless communication device 29. The wireless communication device 29 can wirelessly communicate with the management device 3.

[Work Site]

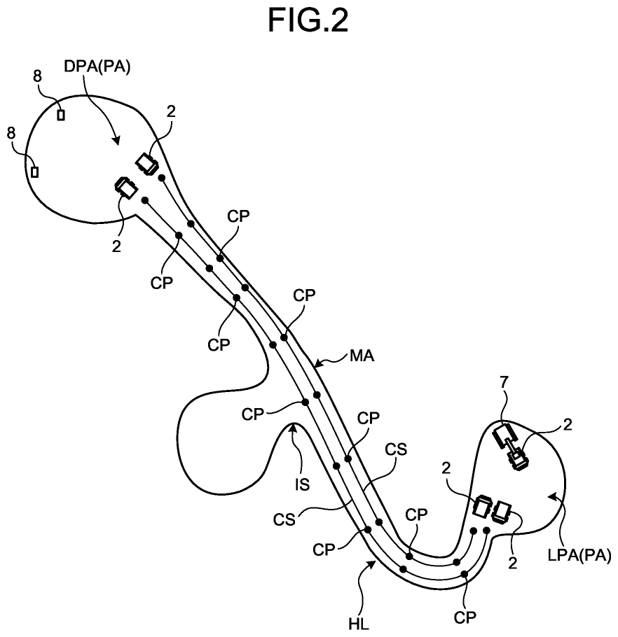

FIG. 2 is a diagram schematically illustrating an example of a work site according to the embodiment. In the embodiment, the work site is a mine or quarry. A mine is a place or place of business where minerals are mined. A quarry is a place or place of business where rocks are mined. Examples of cargo carried by the work vehicle 2 include ore or earth and sand excavated in a mine or a quarry.

The work vehicle 2 travels on at least a part of a work place PA and a traveling road HL leading to the work place PA. The work place PA includes at least one of the loading place LPA and the soil discharging place DPA. The traveling road HL includes an intersection IS.

The loading place LPA refers to an area where the loading work for loading the cargo on the work vehicle 2 is carried out. At the loading place LPA, a loader 7 such as an excavator operates. The soil discharging place DPA refers to an area where the discharge work is carried out, in which the cargo is discharged from the work vehicle 2. For example, a crusher 8 is installed in the soil discharging place DPA.

In the following description, an area where the work vehicle 2 can travel at the work site, such as the traveling road HL and the work place PA, is appropriately referred to as a traveling area MA.

The work vehicle 2 travels in the traveling area MA based on the traveling course data indicating the traveling conditions of the work vehicle 2. As illustrated in FIG. 2, the traveling course data includes a plurality of course points CP set at intervals. The target traveling speed and the target traveling direction of the work vehicle 2 are set for each of the plurality of course points CP. In addition, the traveling course data includes the traveling course CS set in the traveling area MA. The traveling course CS indicates the target traveling route of the work vehicle 2. The traveling course CS is defined by a line connecting a plurality of course points CP.

The traveling course data is generated in the management device 3. The management device 3 transmits the generated traveling course data to the control device 30 of the work vehicle 2 via the communication system 4. The control device 30 controls a traveling device 21 so that the work vehicle 2 travels along the traveling course CS based on the traveling course data and travels according to the target traveling speed and the target traveling direction set for each of the plurality of course points CP.

[Obstacle Sensor]

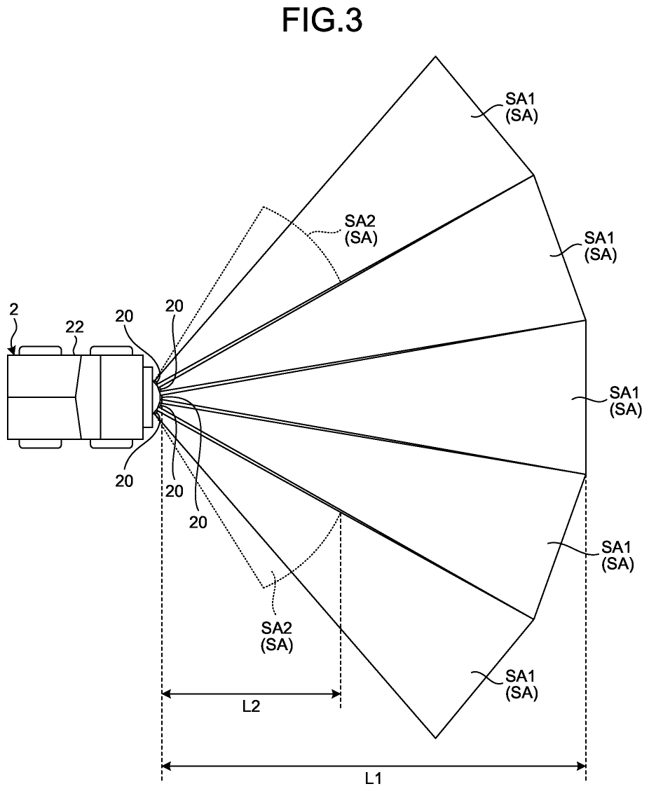

FIG. 3 is a diagram schematically illustrating an example of the obstacle sensor 20 according to the embodiment. A plurality of obstacle sensors 20 are provided at the front portion of the vehicle body 22. A plurality of obstacle sensors 20 are arranged in the front portion of the vehicle body 22 in the vehicle width direction of the work vehicle 2. In the embodiment, five obstacle sensors 20 are arranged in the vehicle width direction. Note that the obstacle sensor 20 is provided also at a rear portion of the vehicle body 22.

The obstacle sensor 20 emits radio waves as a detection wave. In the following description, the area irradiated with the detection wave is appropriately referred to as a detection area SA.

The detection area SA is defined in front of the work vehicle 2. The obstacle sensor 20 can detect an object existing in the detection area SA. The detection area SA extends radially from the obstacle sensor 20 in each of the vertical direction and the vehicle width direction.

The obstacle sensor 20 can set a plurality of detection areas SA. That is, the obstacle sensor 20 can change the area irradiated with the detection wave. The detection area SA includes a long detection area SA1 having a first length L1 in the traveling direction of the work vehicle 2 and a short detection area SA2 having a second length L2 in the traveling direction of the work vehicle 2. The first length L1 is longer than the second length L2. When the detection area SA is set to the long detection area SA1, the obstacle sensor 20 can detect a distant object. When the detection area SA is set to the short detection area SA2, the obstacle sensor 20 can detect a near object.

In the vicinity of the obstacle sensor 20, the width of the short detection area SA2 is larger than the width of the long detection area SA1. In the vehicle width direction, the first short detection area SA2 and at least a part of the second short detection area SA2 adjacent to the first short detection area SA2 overlap.

[Traveling Course, Course Area, and Tracking Area]

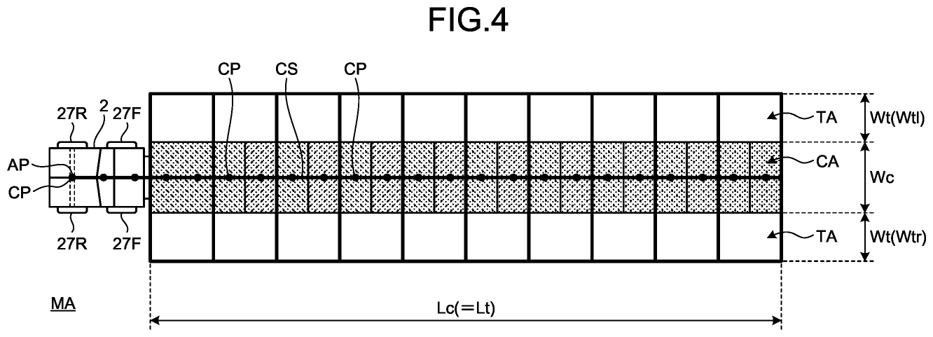

FIG. 4 is a diagram schematically illustrating an example of the traveling course CS, the course area CA, and the tracking area TA according to the embodiment. FIG. 4 illustrates an example in which the traveling course CS is linear.

The work vehicle 2 travels in the traveling area MA along the traveling course CS. The work vehicle 2 travels in the traveling area MA so that a specific part AP of the work vehicle 2 moves along the traveling course CS. The specific part AP of the work vehicle 2 is defined, for example, at the center of an axle supporting the rear wheels 27R. Note that the specific part AP does not have to be defined on the axle.

In the traveling area MA, a course area CA indicating an area through which the work vehicle 2 passes is set. Further, in the traveling area MA, a tracking area TA is set outside the course area CA. The tracking area TA is set outside the course area CA in the vehicle width direction of the work vehicle 2. Each of the course area CA and the tracking area TA is set to the detection area SA of the obstacle sensor 20. In addition, each of the course area CA and the tracking area TA is set on a map of the work site.

The course area CA means an area through which the work vehicle 2 traveling in the traveling area MA passes. That is, the course area CA is an area through which the work vehicle 2 is scheduled to pass.

In the embodiment, the course area CA is set based on the traveling course data including the traveling course CS. The course area CA is an area through which the work vehicle 2 traveling along the traveling course CS passes.

The course area CA has a specified length Lc in the traveling direction of the work vehicle 2 and a specified width Wc in the vehicle width direction of the work vehicle 2. The width Wc of the course area CA is substantially equal to, for example, the width dimension of the work vehicle 2. Note that the width Wc of the course area CA may be larger than the width dimension of the work vehicle 2. For example, the width Wc of the course area CA may be larger than the width dimension of the work vehicle 2 in consideration of the position measurement error of the work vehicle 2 or the control error of the work vehicle 2.

The tracking area TA is an area for tracking obstacles without the work vehicle 2 passing through. The tracking area TA is set so as to be adjacent to the course area CA in the vehicle width direction. The tracking areas TA are set on both sides of the course area CA in the vehicle width direction. In the embodiment, the tracking area CA is set based on the traveling course data including the traveling course CS and the course area CA.

The tracking area TA has a specified length Lt in the traveling direction of the work vehicle 2 and a specified width Wt in the vehicle width direction of the work vehicle 2. The length Lt of the tracking area TA is substantially equal to the length Lc of the course area CA. The width Wt of the tracking area TA includes a width Wtr of the tracking area TA adjacent to one end of the course area CA in the vehicle width direction and a width Wtl of the tracking area TA adjacent to the other end of the course area CA in the vehicle width direction. The width Wtr and the width Wtl are substantially equal.

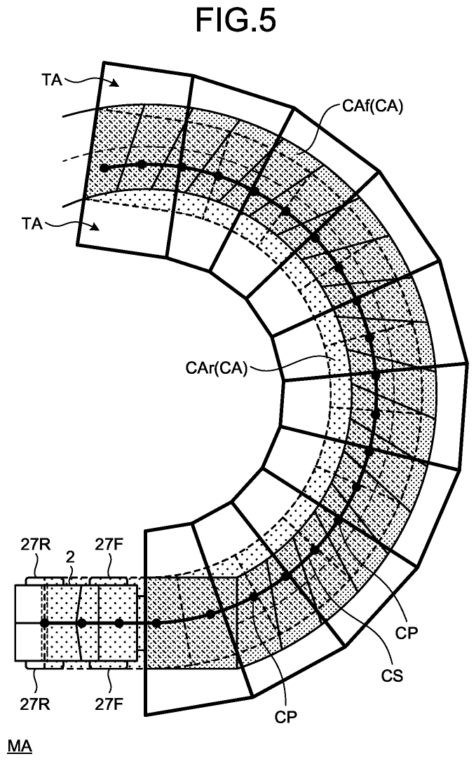

FIG. 5 is a diagram schematically illustrating an example of the traveling course CS, the course area CA, and the tracking area TA according to the embodiment. FIG. 5 illustrates an example in which the traveling course CS is curved. The shape of the course area CA is set based on a turning radius of the work vehicle 2. The shape of the tracking area TA is set based on the shape of the course area CA.

The curvature of the course area CA is determined based on the turning radius of the work vehicle 2. The course area CA is bent so that the turning radius of the work vehicle 2 and the radius of curvature of the course area CA match. As illustrated in FIG. 4, when the work vehicle 2 goes straight, the course area CA is set to be linear. The tracking area TA is bent based on the curvature of the course area CA. The tracking area TA is bent so that the radius of curvature of the course area CA and the radius of curvature of the tracking area TA match.

In the embodiment, the course area CA is set based on the traveling course CS. The traveling course CS defines the turning radius of the work vehicle 2. The tracking area TA is set based on at least one of the traveling course CA and the course area CA. When the traveling course CS is curved, the course area CA is bent so that the radius of curvature of the traveling course CS and the radius of curvature of the course area CA match. When the traveling course CS and the course area CA are curved, the tracking area TA is bent so that at least one of the radius of curvature of the traveling course CS and the radius of curvature of the course area CA coincides with the radius of curvature of the tracking area TA.

As illustrated in FIG. 5, the course area CA includes a first course area CAf and a second course area CAr. The first course area CAf is an area through which the front portion of the work vehicle 2 passes. The second course area CAr is an area through which the rear portion of the work vehicle 2 passes. The second course area CAr is set forward from the rear wheel 27R. Due to an inner wheel difference of the work vehicle 2, an area through which the front portion (front wheel 27F) of the work vehicle 2 passes and an area through which the rear portion (rear wheel 27R) of the work vehicle 2 passes may differ. By setting both the first course area CAf through which the front portion of the work vehicle 2 passes and the second course area CAr through which the front portion of the work vehicle 2 passes, collision between the obstacles existing in both of the first course area CAf and the second course area CAr and the work vehicle 2 is avoided.

The width Wt of the tracking area TA is set so that even when the work vehicle 2 turns at the minimum turning radius, that is, even when the work vehicle 2 turns with the inner wheel difference of the work vehicle 2 being the largest, the tracking area TA is set outside each of the first course area CAf and the second course area CAr in the vehicle width direction.

[Course area, Tracking Area, and Object Detection Point]

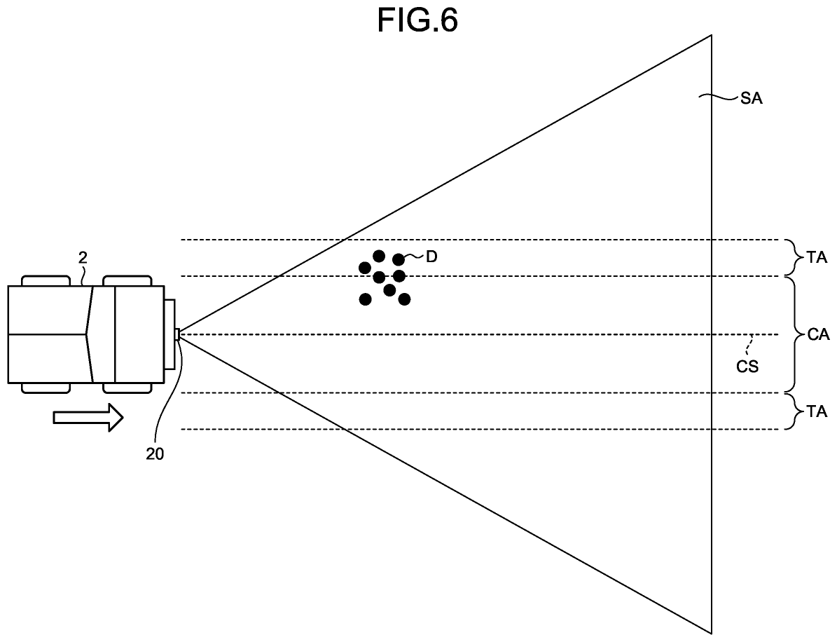

FIG. 6 is a diagram schematically illustrating a course area CA, a tracking area TA, and a detection point D of an object detected by the obstacle sensor 20 according to the embodiment. Note that in the following description, for the purpose of simplifying the description, a plurality of detection areas SA will be described as one detection area SA.

The course area CA is an area where processing for avoiding a collision between the work vehicle 2 and an object is executed. When an object is detected in the course area CA, the control device 30 executes processing for avoiding a collision between the work vehicle 2 and the object. The processing for avoiding the collision between the work vehicle 2 and the object includes at least one of processing for limiting a traveling speed of the work vehicle 2 so that the work vehicle 2 does not collide with the object, and processing for controlling the steering device 26 so that the work vehicle 2 does not collide with the object.

The obstacle sensor 20 detects an object in a state of being mounted on the front portion of the work vehicle 2 while the work vehicle 2 is traveling. Further, the obstacle sensor 20 detects an object while scanning the detection wave in the detection area SA in each of the vertical direction and the vehicle width direction. That is, the obstacle sensor 20 detects an object at a specified cycle in a state of being mounted on the work vehicle 2 while the work vehicle 2 is traveling.

For example, due to insufficient detection accuracy of the obstacle sensor 20, there is a possibility that the obstacle sensor 20 erroneously detects that an object exists in the course area CA even though the object does not exist in the course area CA, or erroneously detects that an object does not exist in the course area CA even though the object exists in the course area CA.

For example, when the obstacle sensor 20 detects one object at a specified cycle, there is a possibility that a phenomenon in which a position of the detection point D of the object detected by the obstacle sensor 20 fluctuates due to insufficient detection accuracy of the obstacle sensor 20 occurs.

That is, as illustrated in FIG. 6, when the object exists inside the course area CA and near the end of the course area CA, or when the object exists outside the course area CA and near the end of the course area CA, there is a possibility that the detection points D of the object detected at a specified cycle exist in each of the inside of the course area CA and the outside of the course area CA.

When the object exists inside the course area CA, it is necessary to execute processing for avoiding a collision between the work vehicle 2 and the object. If it is erroneously detected that the detection point D of the object exists outside the course area CA even though the object exists inside the course area CA, there is a possibility that the processing for avoiding a collision between the work vehicle 2 and the object is not executed.

When the object exists outside the course area CA, it is not necessary to execute the processing for avoiding the collision between the work vehicle 2 and the object. If it is erroneously detected that the detection point D of the object exists inside the course area CA even though the object exists outside the course area CA, there is a possibility that the processing for avoiding the collision between the work vehicle 2 and the object is executed unnecessarily.

In the present disclosure, the tracking area TA is set so as to be adjacent to the course area CA outside the course area CA. Each of the course area CA and the tracking area TA is an area in which the detection point D of the object detected by the obstacle sensor 20 is tracked.

When the obstacle sensor 20 detects an object in the course area CA and at least a part of the tracking area TA, the control device 30 tracks the detection point D of the object. As a result, when the obstacle sensor 20 erroneously detects that the object exists inside the course area CA even though the object exists outside the course area CA, and also when the obstacle sensor 20 erroneously detects that the object exists outside the course area CA even though the object exists inside the course area CA, the control device 30 can control traveling of the work vehicle 2 so as to avoid the collision between the work vehicle 2 and the object based on the tracking result of the detection point D. For example, the control device 30, when determining that the tracked detection point D satisfies the specified stop condition based on the tracking result of the detection point D, executes processing for avoiding a collision between the work vehicle 2 and the object. As a result, the collision between the work vehicle 2 and the object is avoided. On the other hand, the control device 30, when determining that the tracked detection point D does not satisfy the specified stop condition based on the tracking result of the detection point D, does not execute the processing for avoiding a collision between the work vehicle 2 and the object. As a result, for example, the traveling of the work vehicle is not unnecessarily stopped, so that the decrease in productivity at the work site is suppressed.

[Management Device and Control Device]

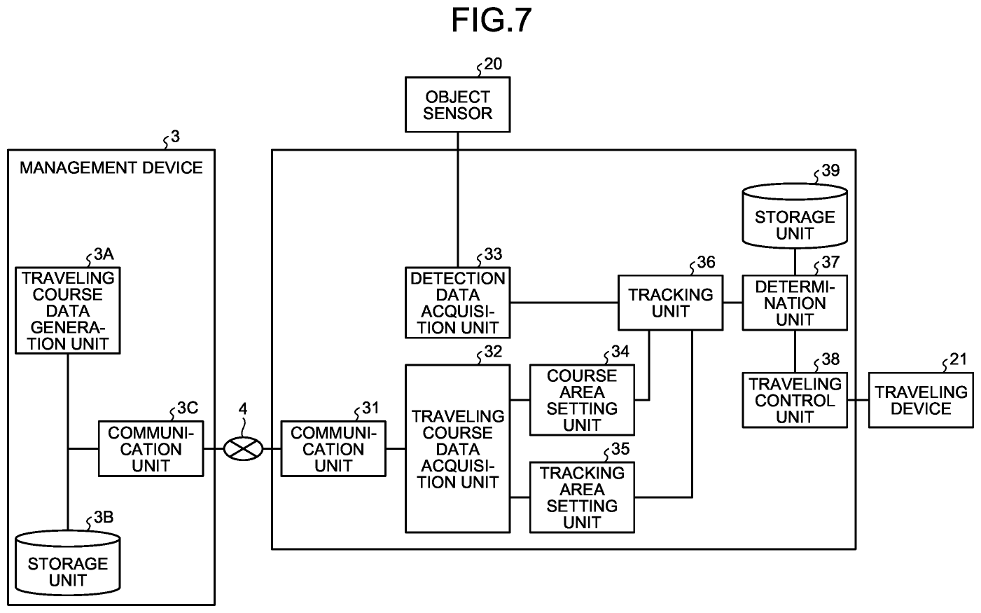

FIG. 7 is a functional block diagram illustrating an example of the management device 3 and the control device 30 according to the embodiment. The control device 30 can communicate with the management device 3 via the communication system 4.

The management device 3 includes a traveling course data generation unit 3A for generating traveling course data, a storage unit 3B, and a communication unit 3C.

The traveling course data generation unit 3A generates traveling course data including the traveling course CS of the work vehicle 2. The traveling course CS refers to the target traveling route of the work vehicle 2. The traveling course data includes the target traveling speed and the target traveling direction at each of the plurality of course points CP set at intervals in the traveling course CS. The storage unit 3B stores a program required for generating the traveling course data in the traveling course data generation unit 3A. The traveling course data generation unit 3A outputs the generated traveling course data to the communication unit 3C. The communication unit 3C transmits the traveling course data to the control device 30 of the work vehicle 2.

The control device 30 includes a communication unit 31, a traveling course data acquisition unit 32, a detection data acquisition unit 33, a course area setting unit 34, a tracking area setting unit 35, a tracking unit 36, a determination unit 37, a traveling control unit 38 and a storage unit 39.

The traveling course data acquisition unit 32 acquires traveling course data indicating the traveling conditions of the work vehicle 2. The traveling course data is transmitted from the management device 3 to the control device 30. The traveling course data acquisition unit 32 acquires the traveling course data transmitted from the management device 3 via the communication unit 31.

The detection data acquisition unit 33 acquires the detection data of the obstacle sensor 20 that has detected an object existing in front of the work vehicle 2. The detection data of the obstacle sensor 20 includes a detection point D indicating an object detected by the obstacle sensor 20, as described with reference to FIG. 6. The detection data acquisition unit 33 acquires the detection point D detected by the obstacle sensor 20.

The obstacle sensor 20 detects an object existing in each of the course area CA and the tracking area TA. The detection data acquisition unit 33 acquires a detection point D indicating an object detected by the obstacle sensor 20 in each of the course area CA and the tracking area TA.

The detection point D includes the relative position data between the obstacle sensor 20 and the object. The relative position data between the obstacle sensor 20 and the object includes at least one of the relative distance and the relative angle between the obstacle sensor 20 and the object.

The course area setting unit 34 sets a course area CA having a specified length Lc in the traveling direction of the work vehicle 2 and a specified width Wc in the vehicle width direction and indicating an area through which the work vehicle 2 passes. The width Wc of the course area CA may be the same as the vehicle width dimension of the work vehicle 2, or may be slightly larger than the vehicle width dimension of the work vehicle 2. The course area setting unit 34 sets the course area CA to the detection area SA of the obstacle sensor 20.

The course area setting unit 34 bends the course area CA based on the turning radius of the work vehicle 2. When the work vehicle 2 travels linearly, the course area setting unit 34 sets the linear course area CA. When the work vehicle 2 turns, the course area setting unit 34 sets the course area CA so that the turning radius of the work vehicle 2 and the radius of curvature of the course area CA match.

In the embodiment, the course area setting unit 34 sets the course area CA based on the traveling course data. The course area setting unit 34 sets the course area CA so that the traveling course CS is arranged at the center of the course area CA in the vehicle width direction. The traveling course CS defines the turning radius of the work vehicle 2. When the traveling course CS is linear, the course area setting unit 34 sets the linear course area CA so as to include the traveling course CS. When the traveling course CS is curved, the course area setting unit 34 sets the curved course area CA so as to include the traveling course CS.

The tracking area setting unit 35 sets the tracking area TA outside the course area CA in the vehicle width direction of the work vehicle 2. The tracking area setting unit 35 sets the course area CA which has a specified length Lt in the traveling direction and a specified width Wt in the vehicle width direction and through which the work vehicle 2 does not pass. The tracking area setting unit 35 sets the tracking area TA to the detection area SA of the obstacle sensor 20.

The tracking area setting unit 35 bends the tracking area TA based on the radius of curvature of the course area CA. When the course area CA is linear, the tracking area setting unit 35 sets the linear tracking area TA. When the course area CA is curved, the tracking area setting unit 35 sets the tracking area TA so that the radius of curvature of the course area CA and the radius of curvature of the tracking area TA match.

In the embodiment, the tracking area setting unit 35 sets the tracking area TA based on the traveling course data and the course area CA. The tracking area setting unit 35 sets the tracking area TA so that the traveling course CS is arranged at the center of the tracking area TA in the vehicle width direction and the tracking areas TA are arranged on both sides of the course area CA in the vehicle width direction. When the traveling course CS and the course area CA are linear, the tracking area setting unit 35 sets the linear tracking area TA so as to include the traveling course CS and the course area CA. When the traveling course CS and the course area CA are curved, the tracking area setting unit 35 sets the curved tracking area TA so as to include the traveling course CS and the course area CA.

The tracking unit 36 tracks the detection point D of the object detected by the obstacle sensor 20 in the course area CA and at least a part of the tracking area TA outside the course area CA. In the following description, the detection point D tracked by the tracking unit 36 is appropriately referred to as a tracking detection point Dt.

The tracking detection point Dt is a detection point D existing in at least one of the course area CA and the tracking area TA.

The determination unit 37 determines whether or not the tracking detection point Dt tracked by the tracking unit 36 satisfies the specified stop condition. The stop condition includes a condition in which an object is likely to exist in the course area CA. That is, the stop condition includes a condition in which the work vehicle 2 and the object are likely to collide with each other. The stop condition is a predetermined condition and is stored in the storage unit 39.

As described above, the obstacle sensor 20 irradiates the object with a detection wave to detect the object. The stop condition includes that the reflection intensity of the detection wave from the tracking detection point Dt existing in the course area CA is equal to or higher than the reflection intensity threshold. The reflection intensity threshold is a predetermined value and is stored in the storage unit 39. The reflection intensity threshold can be set by measuring the reflection intensity related to an obstacle such as a vehicle or rock.

Further, as described above, the obstacle sensor 20 detects an object at a specified cycle in the traveling of the work vehicle 2 in a state of being mounted on the work vehicle 2. The stop condition includes that the number of times that the reflection intensity detected at the specified cycle is equal to or higher than the reflection intensity threshold is equal to or greater than the number of times threshold. The number of times threshold is a predetermined value and is stored in the storage unit 39.

The traveling control unit 38 controls the traveling of the work vehicle 2 based on the tracking result of the tracking detection point Dt by the tracking unit 36.

When the determination unit 37 determines that the tracking detection point Dt satisfies the stop condition, the traveling control unit 38 outputs an avoidance command for avoiding a collision between the work vehicle 2 and the object.

The avoidance command includes at least one of a command for limiting the traveling speed of the work vehicle 2 and a command for controlling the steering device 26 of the work vehicle 2. The command for limiting the traveling speed of the work vehicle 2 includes a command for reducing the traveling speed of the work vehicle 2 or a command for stopping the traveling of the work vehicle 2. The command for controlling the steering device 26 of the work vehicle 2 includes a command for controlling the steering device 26 of the work vehicle 2 so as to avoid a collision between the work vehicle 2 and an object existing in the course area CA.

In the embodiment, the command for limiting the traveling speed of the work vehicle 2 includes a command for reducing the traveling speed of the work vehicle 2 from the target traveling speed defined by the traveling course data or a command for stopping the traveling of the work vehicle 2. The command for controlling the steering device 26 of the work vehicle 2 includes a control for making the work vehicle 2 travel in a traveling direction different from the target traveling direction defined by the traveling course data.

When the determination unit 37 determines that the tracking detection point Dt does not satisfy the stop condition, the traveling control unit 38 controls the traveling of the work vehicle 2 based on the traveling course data.

[Tracking Detection Point]

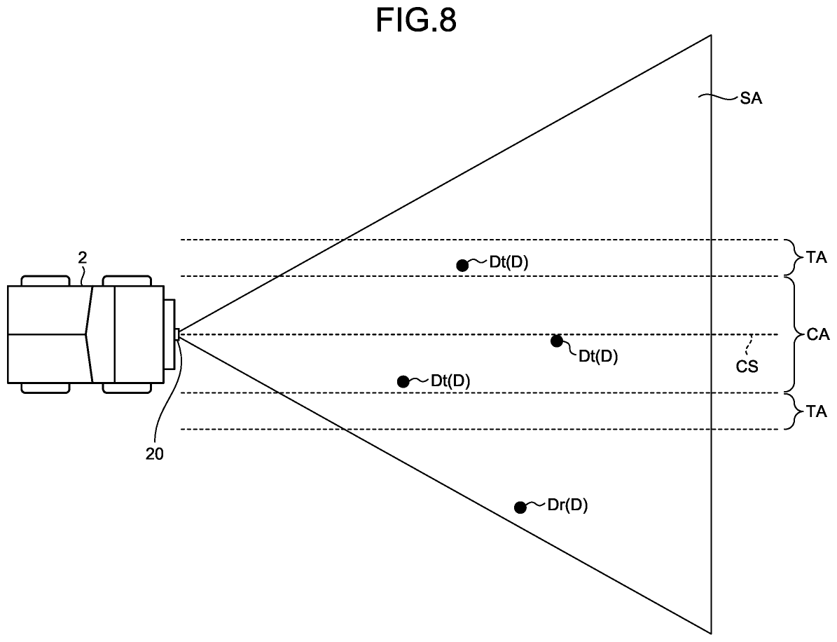

FIG. 8 is a diagram for explaining the tracking detection point Dt according to the embodiment. As illustrated in FIG. 8, the tracking detection point Dt is a detection point D existing in at least one of the course area CA and the tracking area TA.

The detection data acquisition unit 33 acquires the detection point D of the object existing in the detection area SA from the obstacle sensor 20. The tracking unit 36 tracks the detection point D existing in at least one of the course area CA and the tracking area TA among the detection points D acquired by the detection data acquisition unit 33. In the example illustrated in FIG. 8, four detection points D exist in the detection area SA. Of the four detection points D, the tracking unit 36 determines three detection points D existing in the course area CA and the tracking area TA as the tracking detection points Dt, and tracks the determined tracking detection points Dt. In the example illustrated in FIG. 8, the detection point D existing outside the tracking area TA is a non-tracking detection point Dr. The tracking unit 36 does not track the non-tracking detection point Dr.

Note that, the tracking unit 36 may estimate the position of the detection point DP by processing the position data of the detection point DP acquired by the detection data acquisition unit 33 with a Kalman filter. The tracking unit 36 may determine whether or not the detection point DP exists in at least one of the course area CA and the tracking area TA based on the estimated position of the detection point DP. By estimating the position of the detection point DP with the Kalman filter, the fluctuation amount of the position of the detection point DP related to a certain object is suppressed as explained with reference to FIG. 6.

[Integration of Detection Points]

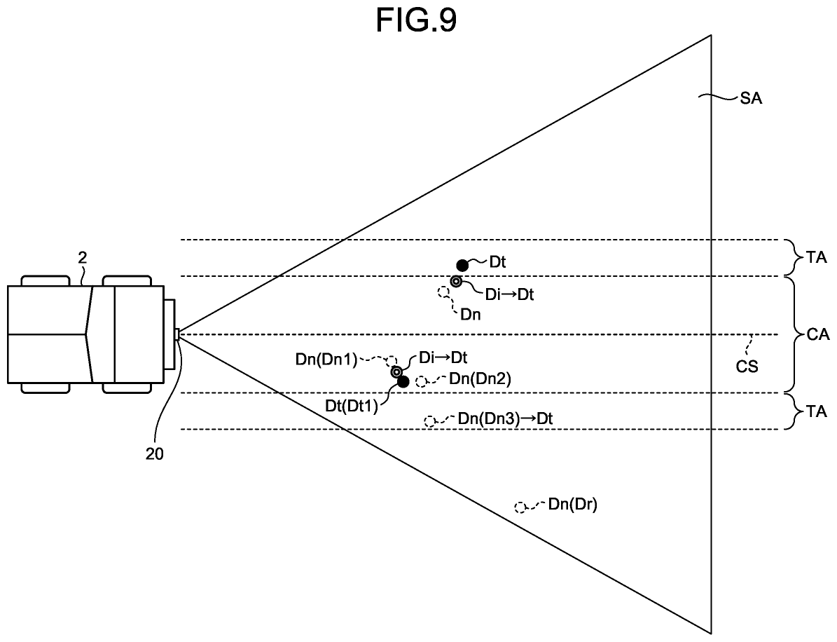

FIG. 9 is a diagram for explaining the processing by the tracking unit 36 according to the embodiment. In the present disclosure, as the tracking detection point Dt, a new detection point Dn indicating the detection point D immediately after being detected by the obstacle sensor 20 and acquired by the detection data acquisition unit 33 is provided. Further, as the tracking detection point Dt, an integrated detection point Di generated by integrating a plurality of detection points D is provided. The integrated detection point Di is generated by integrating the tracking detection point Dt already tracked by the tracking unit 36 and the new detection point Dn acquired by the detection data acquisition unit 33.

By integrating the tracking detection point Dt and the new detection point Dn to provide the integrated detection point Di, the tracking can be continued even in a situation where quality of the accuracy of the detection point D cannot be determined.

The position data of the tracking detection point Dt that has already been tracked by the tracking unit 36 is stored in the storage unit 39. The detection data acquisition unit 33 acquires a new detection point Dn indicating the detection point DP detected by the obstacle sensor 20.

When the tracking detection point Dt that has already been tracked and the new detection point Dn acquired by the detection data acquisition unit 33 satisfy the specified integration condition, the tracking unit 36 integrates the tracking detection point Dt and the new detection point Dn to generate the integrated detection point Di. The tracking unit 36 tracks the integrated detection point Di generated by integrating the tracking detection point Dt and the new detection point Dn as a new tracking detection point Dt.

The integration of the tracking detection point Dt and the new detection point Dn may include, for example, calculating the position of the midpoint between the tracking detection point Dt and the new detection point Dn. That is, the tracking unit 36 may determine the midpoint between the tracking detection point Dt and the new detection point Dn as the integrated detection point Di. Note that the tracking unit 36 may calculate the integrated detection point Di by integrating the tracking detection point Dt and the new detection point Dn using a Kalman filter.

When the tracking detection point Dt that has already been tracked and the new detection point Dn acquired by the detection data acquisition unit 33 do not satisfy the specified integration condition, the tracking unit 36 does not integrate the tracking detection point Dt and the new detection point Dn. The tracking unit 36 continues tracking the tracking detection point Dt that has already been tracked. In addition, the tracking unit 36 tracks the new detection point Dn as a new tracking detection point Dt.

The integration condition is a predetermined condition and is stored in the storage unit 39. In the embodiment, the integration condition includes that the distance between the tracking detection point Dt and the new detection point Dn is equal to or less than a distance threshold.

As described above, the obstacle sensor 20 detects an object at a specified cycle. The detection data acquisition unit 33 acquires the new detection point Dn detected at a first time point. When the new detection point Dn detected at the first time point exists in the course area CA and at least a part of the tracking area TA, the tracking unit 36 determines the new detection point Dn detected at the first time point as a tracking detection point Dt, and starts tracking the tracking detection point Dt. That is, the tracking unit 36 starts tracking the tracking detection point Dt detected at the first time point. Further, the position data of the tracking detection point Dt detected at the first time point is stored in the storage unit 39.

The detection data acquisition unit 33 acquires the new detection point Dn detected at a second time point after the first time point. The tracking unit 36 calculates the distance between the tracking detection point Dt detected at the first time point and the new detection point Dn detected at the second time point. When the distance between the tracking detection point Dt detected at the first time point and the new detection point Dn detected at the second time point is equal to or less than the distance threshold, the tracking unit 36 determines that the integration condition is satisfied.

As illustrated in FIG. 9, the tracking unit 36 integrates the tracking detection point Dt and the new detection point Dn to generate the integrated detection point Di. The tracking unit 36 tracks the integrated detection point Di generated by integrating the tracking detection point Dt and the new detection point Dn as a new tracking detection point Dt.

In the example illustrated in FIG. 9, a new detection point Dn1 and a new detection point Dn2 exist around a tracking detection point Dt1. The distance between the tracking detection point Dt1 and the new detection point Dn1 is equal to or less than the distance threshold. The distance between the tracking detection point Dt1 and the new detection point Dn2 is also equal to or less than the distance threshold. When there are a plurality of new detection points Dn whose distances from the tracking detection point Dt1 are equal to or less than the distance threshold, the tracking unit 36 integrates the tracking detection point Dt1 and the new detection point Dn closest to the tracking detection point Dt1. In the example illustrated in FIG. 9, the distance between the tracking detection point Dt1 and the new detection point Dn1 is shorter than the distance between the tracking detection point Dt1 and the new detection point Dn2. The tracking unit 36 integrates the tracking detection point Dt1 and the new detection point Dn1 to generate an integrated detection point Di. The new detection point Dn2 is deleted.

Further, in the example illustrated in FIG. 9, there is no tracking detection point Dt around a new detection point Dn3. That is, there is no tracking detection point Dt whose distance from the new detection point Dn3 is equal to or less than the distance threshold. The tracking unit 36 determines that the new detection point Dn3 does not satisfy the integration condition. The tracking unit 36 tracks the new detection point Dn3 as a new tracking detection point Dt.

The tracking unit 36 does not execute integration and tracking for the new detection point Dn (non-tracking detection point Dr) existing outside the course area CA and the tracking area TA.

The new detection point Dn whose distance from the tracking detection point Dt is equal to or less than the distance threshold can be regarded as the detection point DP of the object already existing in at least one of the course area CA and the tracking area TA at the first time point. Therefore, when the distance between the tracking detection point Dt and the new detection point Dn is equal to or less than the distance threshold, the tracking unit 36 integrates the tracking detection point Dt and the new detection point Dn to generate an integrated detection point Di, determines the generated integrated detection point Di is as a new tracking detection point Dt, and starts tracking the determined tracking detection point Dt.

The new detection point Dn whose distance from the tracking detection point Dt is larger than the distance threshold does not exist in the course area CA and the tracking area TA at the first time point, and can be regarded as the detection point DP of the object newly existing in at least one of the course area CA and the tracking area TA at the second time point. Therefore, when the distance between the tracking detection point Dt and the new detection point Dn is larger than the distance threshold, the tracking unit 36 does not integrate the tracking detection point Dt and the new detection point Dn, determines the new detection point Dn as a new tracking detection point Dt, and starts tracking the determined tracking detection point Dt.

At a third time point after the second time point, the tracking unit 36 determines whether or not the tracking detection point Dt determined at the second time point and the new detection point Dn detected at the third time point satisfy the integration condition, and executes the same processing as described above. The tracking unit 36 repeats the above-mentioned processing at a specified cycle.

[Stop Condition]

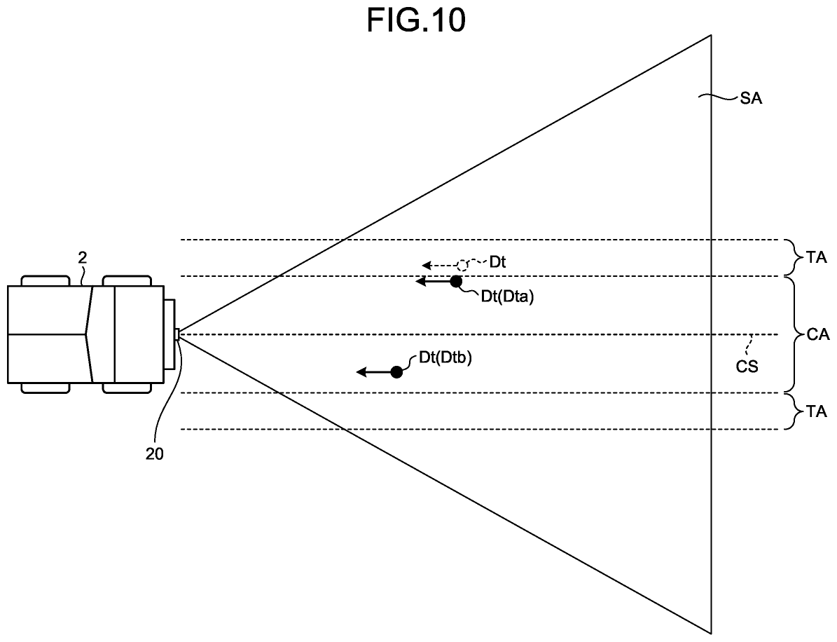

FIG. 10 is a diagram for explaining a stop condition according to the embodiment. The stop condition includes that the reflection intensity of the detection wave from the tracking detection point Dt existing in the course area CA is equal to or higher than the reflection intensity threshold. Further, the stop condition includes that the number of times that the reflection intensity of the detection wave from the tracking detection point Dt detected at a specified cycle is equal to or higher than the reflection intensity threshold is equal to or greater than the number of times threshold.

In FIG. 10, a tracking detection point Dta and a tracking detection point Dtb are the tracking detection points Dt that are continuously arranged in the course area CA from the first time point to the Nth time point. When an object related to the tracking detection point Dt is irradiated with the detection wave emitted from the obstacle sensor 20, the detection wave reflected by the object is received by the obstacle sensor 20. The stop condition includes that the reflection intensity of the detection wave transmitted from the tracking detection point Dt existing in the course area CA and received by the obstacle sensor 20 is equal to or higher than a predetermined reflection intensity threshold.

The obstacle sensor 20 receives the detection wave from the tracking detection point Dt at a specified cycle. The stop condition includes that the number of times that the reflection intensity of the detection wave received by the obstacle sensor 20 at the specified cycle is equal to or higher than the reflection intensity threshold is equal to or greater than a predetermined number of times threshold.

The obstacle sensor 20 receives a plurality of detection waves from the tracking detection point Dt. When the number of times that the obstacle sensor 20 receives the detection wave whose reflection intensity is equal to or higher than the reflection threshold among the detection waves received N times is equal to or greater than the number of times threshold, the tracking detection point Dt satisfies the stop condition.

For example, when the number of times that the obstacle sensor 20 receives a detection wave whose reflection intensity is equal to or higher than the reflection intensity threshold among the detection waves received N times from the tracking detection point Dta is equal to or greater than the number of times threshold, the tracking detection point Dta is determined to satisfy the stop condition. When the number of times that the obstacle sensor 20 receives a detection wave whose reflection intensity is equal to or higher than the reflection intensity threshold among the detection waves received N times from the tracking detection point Dtb is less than the number of times threshold, the tracking detection point Dtb is determined not to satisfy the stop condition.

The tracking detection point Dt arranged in the tracking area TA does not satisfy the stop condition.

The determination unit 37 determines whether or not the tracking detection point Dt existing in the course area CA satisfies the stop condition. When the tracking detection point Dt satisfying the stop condition exists in the course area CA, the determination unit 37 determines that an object (obstacle) exists in the course area CA. When the tracking detection point Dt satisfying the stop condition does not exist in the course area CA, the determination unit 37 determines that there is no object (obstacle) in the course area CA.

The traveling control unit 38 controls the traveling of the work vehicle 2 based on the tracking result of the tracking detection point Dt. When the determination unit 37 determines that the tracking detection point Dt satisfies the stop condition, that is, when it determines that an object exists in the course area CA, the traveling control unit 38 outputs an avoidance command for avoiding a collision between the work vehicle 2 and the object. When the determination unit 37 determines that the tracking detection point Dt does not satisfy the stop condition, that is, when it determines that there is no object in the course area CA, the traveling control unit 38 controls the traveling of the work vehicle 2 based on the traveling course data.

As described above, the avoidance command includes at least one of a command for limiting the traveling speed of the work vehicle 2 and a command for controlling the steering device 26 of the work vehicle 2. In the embodiments, the number of times threshold includes a first number of times threshold and a second number of times threshold. The first number of times threshold is, for example, 50 times. The second number of times threshold is, for example, 100 times. In the embodiment, the traveling control unit 38 reduces the traveling speed of the work vehicle 2 when the number of times that the reflection intensity detected at a specified cycle is equal to or higher than the reflection intensity threshold is equal to or greater than the first number of times threshold and less than the second number of times threshold. The traveling control unit 38 stops the traveling of the work vehicle 2 when the number of times that the reflection intensity detected at the specified cycle is equal to or higher than the reflection intensity threshold is equal to or greater than the second number of times threshold. By providing two number of times thresholds, a first number of times threshold and a second number of times threshold, it is not necessary to stop the traveling of the work vehicle 2 when the possibility of collision is relatively low.

[Control Method]

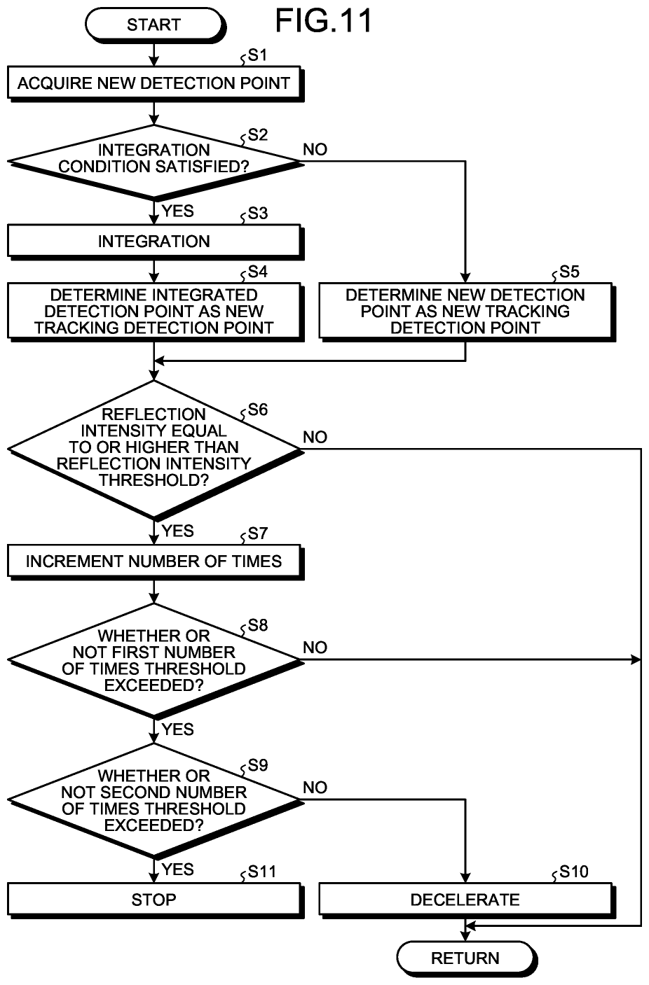

FIG. 11 is a flowchart illustrating an example of the control method of the work vehicle 2 according to the embodiment.

The work vehicle 2 starts traveling in the traveling area MA. The obstacle sensor 20 detects an object in front of the work vehicle 2. The detection data acquisition unit 33 acquires a new detection point Dn detected by the obstacle sensor 20. When the new detection point Dn exists in at least one of the course area CA and the tracking area TA, the tracking unit 36 determines the new detection point Dn as the tracking detection point Dt and starts tracking the tracking detection point Dt. The storage unit 39 stores the position data of the tracking detection point Dt.

The obstacle sensor 20 detects an object at intervals of a specified cycle in the traveling of the work vehicle 2. The detection data acquisition unit 33 acquires a new detection point Dn detected by the obstacle sensor 20 (Step S1).

The tracking unit 36 determines whether or not the tracking detection point Dt that is being tracked and the new detection point Dn satisfy the integration condition. The integration condition includes that the distance between the tracking detection point Dt and the new detection point Dn is equal to or less than the distance threshold. The tracking unit 36 determines whether or not the distance between the tracking detection point Dt and the new detection point Dn is equal to or less than the distance threshold (Step S2).

If it is determined in Step S2 that the integration condition is satisfied (Step S2: Yes), the tracking unit 36 integrates the tracking detection point Dt and the new detection point Dn to generate an integrated detection point Di (Step S3).

Note that, as described with reference to FIG. 9, when there are a plurality of new detection points Dn whose distances from the tracking detection point Dt are equal to or less than the distance threshold, the tracking unit 36 integrates the tracking detection point Dt and the new detection point Dn closest to the tracking detection point Dt.

The tracking unit 36 determines the integrated detection point Di generated in Step S3 as a new tracking detection point Dt. The tracking unit 36 starts tracking the newly determined tracking detection point Dt (Step S4).

If it is determined in Step S2 that the integration condition is not satisfied (Step S2: No), the tracking unit 36 does not integrate the tracking detection point Dt and the new detection point Dn, and continues tracking the tracking detection point Dt. Further, the tracking unit 36 determines the new detection point Dn acquired in Step S1 as a new tracking detection point Dt. The tracking unit 36 starts tracking the newly determined tracking detection point Dt (Step S5).

The determination unit 37 determines whether or not the tracking detection point Dt tracked by the tracking unit 36 satisfies the stop condition. In the embodiment, the determination unit 37 determines whether or not the reflection intensity of the detection wave from the tracking detection point Dt existing in the course area CA is equal to or higher than the reflection intensity threshold as a stop condition (Step S6).

If it is determined in Step S6 that the reflection intensity is equal to or higher than the reflection intensity threshold (Step S6: Yes), the determination unit 37 increments the number of times that the reflection intensity is equal to or higher than the reflection intensity threshold (Step S7).

The determination unit 37 determines whether or not the number of times that the reflection intensity is equal to or higher than the reflection intensity threshold exceeds the first number of times threshold (Step S8).

In Step S8, if it is determined that the number of times that the reflection intensity is equal to or higher than the reflection intensity threshold exceeds the first number of times threshold (Step S8: Yes), the determination unit 37 determines whether or not the number of times that the reflection intensity is equal to or higher than the reflection intensity threshold has reached the second number of times threshold (Step S9).

If it is determined in Step S9 that the number of times that the reflection intensity is equal to or higher than the reflection intensity threshold does not exceed the second number of times threshold (Step S9: No), the traveling control unit 38 reduces the traveling speed of the work vehicle 2 (Step S10).

In Step S9, if it is determined that the number of times that the reflection intensity is equal to or higher than the reflection intensity threshold has exceeded the second number of times threshold (Step S9: Yes), the traveling control unit 38 stops the traveling of the work vehicle 2 (Step S11).

If it is determined in Step S6 that the reflection intensity is not equal to or higher than the reflection intensity threshold (Step S6: No), the process returns to Step S1. If it is determined in Step S8 that the number of times that the reflection intensity is equal to or higher than the reflection intensity threshold does not exceed the first number of times threshold (Step S8: No), the process returns to Step S1.

[Computer System]

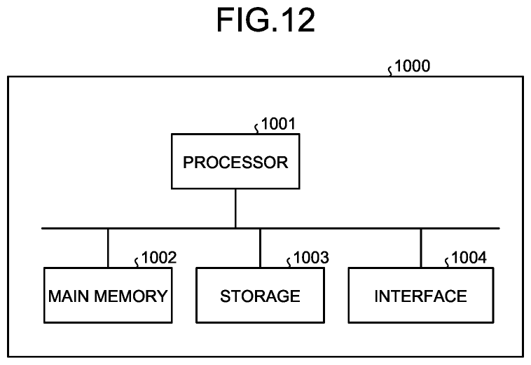

FIG. 12 is a block diagram illustrating an example of a computer system 1000 according to the embodiment. Each of the management device 3 and the control device 30 described above includes a computer system 1000. The computer system 1000 includes a processor 1001 such as a CPU (Central Processing Unit), a main memory 1002 including a non-volatile memory such as ROM (Read Only Memory) and a volatile memory such as RAM (Random Access Memory), a storage 1003, and an interface 1004 including an input/output circuit. The functions of the management device 3 and the functions of the control device 30 described above are stored in the storage 1003 as a program. The processor 1001 reads the program from the storage 1003, expands it into the main memory 1002, and executes the above-described processing according to the program. Note that the program may be distributed to the computer system 1000 via the network.

The computer system 1000 can execute, according to the above-described embodiment, setting the course area CA through which the work vehicle 2 passes, setting the tracking area TA outside the course area CA, tracking the detection point D of the object detected by the obstacle sensor 20 in at least a part of the tracking area TA, and controlling the traveling of the work vehicle 2 based on the tracking result of the detection point D.

[Effect]

As described above, according to the present invention, the tracking unit 36 tracks the detection point DP of the object detected by the obstacle sensor 20 in the course area CA through which the work vehicle 2 passes and at least a part of the tracking area TA outside the course area CA in the vehicle width direction. The traveling control unit 38 controls the traveling of the work vehicle 2 based on the tracking result of the tracking detection point Dt indicating the detection point DP tracked by the tracking unit 36. As a result, as described with reference to FIG. 6, even if the detection accuracy of the obstacle sensor 20 is insufficient, for example, the traveling control unit 38 can control the traveling of the work vehicle 2 so that the decrease in the productivity at the work site is suppressed based on the tracking result of the tracking detection point Dt. For example, the traveling control unit 38 executes processing for avoiding a collision between the work vehicle 2 and an object when it is determined that the tracking detection point Dt satisfies the specified stop condition based on the tracking result of the tracking detection point Dt. As a result, the collision between the work vehicle 2 and the object is avoided. On the other hand, when it is determined that the tracking detection point Dt does not satisfy the specified stop condition based on the tracking result of the tracking detection point Dt, the traveling control unit 38 does not execute the processing for avoiding a collision between the work vehicle 2 and the object. As a result, for example, the traveling of the work vehicle 2 is not unnecessarily stopped, so that a decrease in productivity at the work site is suppressed.

For example, a reflector installed on the shoulder of the traveling road HL or a rock existing on the shoulder does not exist in the course area CA, but it becomes a factor of the stop of the work vehicle 2 when it is determined to be an obstacle by the detection result of the obstacle sensor 20. By setting the tracking area TA for tracking an object that may be an obstacle while the work vehicle 2 is continuously traveling, it is possible to improve the detection accuracy of the obstacle existing in the course area CA. That is, it is determined whether or not the object in the tracking area TA related to the obstacle determination is an obstacle. By providing the tracking area TA instead of simply expanding the course area CA, unnecessary stopping of the work vehicle 2 is suppressed.

The tracking areas TA are set on both sides of the course area CA in the vehicle width direction so as to be adjacent to the course area CA. This makes it possible for the tracking unit 36 to track the tracking detection points Dt existing in the tracking areas TA set on both sides of the course area CA.

The stop condition includes that the reflection intensity of the detection wave from the tracking detection point Dt existing in the course area CA is equal to or higher than the reflection intensity threshold, and that the number of times that the reflection intensity of the detection wave detected at a specified cycle is equal to or higher than the reflection intensity threshold is equal to or greater than the number of times threshold. As a result, the determination unit 37 can accurately determine whether or not there is a high possibility that an object exists in the course area CA.

When the tracking detection point Dt and the new detection point Dn satisfy the integration condition, the tracking unit 36 tracks the integrated detection point Di generated by integrating the tracking detection point Dt and the new detection point Dn as a new tracking detection point Dt. As a result, even if more detection points D than the actual number of objects are detected due to insufficient detection accuracy of the obstacle sensor 20, the tracking detection point Dt and the new detection point Dn are integrated, and thereby it is possible to derive the tracking detection point Dt corresponding to the actual number of objects.

When the tracking detection point Dt and the new detection point Dn do not satisfy the integration condition, the tracking unit 36 tracks the new detection point Dn as a new tracking detection point Dt. This makes it possible to track the detection point DP of an object newly existing in at least one of the course area CA and the tracking area TA.

Each of the course area CA and the tracking area TA is set to the detection area SA of the obstacle sensor 20. As a result, the obstacle sensor 20 can detect the objects existing in the course area CA and the tracking area TA.

The course area CA is bent based on the turning radius of the work vehicle 2. The tracking area TA is bent based on the radius of curvature of the course area CA. As a result, even when the work vehicle 2 turns, the tracking unit 36 can continue to track the course of the work vehicle 2 or the detection point DP of an object existing in the vicinity of the course.

### OTHER EMBODIMENTS

Note that, in the above-described embodiment, at least a part of the functions of the control device 30 of the work vehicle 2 may be provided in the management device 3, or at least a part of the functions of the management device 3 may be provided in the control device 30. For example, the control device 30 of the work vehicle 2 may generate traveling course data. That is, the control device 30 may have a traveling course data generation unit. Further, each of the management device 3 and the control device 30 may have a traveling course data generation unit. Further, the management device 3 may have at least one of the course area setting unit 34 and the tracking area setting unit 35.

In the above-described embodiment, the work vehicle 2 travels based on the traveling course data. The work vehicle 2 may travel by remote control or autonomously.

In the above-described embodiment, the work vehicle 2 is a dump truck which is a kind of transport vehicle. The work vehicle 2 may be a work machine including a working equipment such as an excavator or a bulldozer.

In the above-described embodiment, the work vehicle 2 is an unmanned vehicle that operates unmanned. The work vehicle 2 may be a manned vehicle that is operated by the driving operation of the driver. For example, when a steering wheel for actuating the steering device 26 is provided in the driver's cab of the work vehicle 2, and the driver operates the steering wheel to actuate the steering device 26, the course area CA and the tracking area TA may be bent based on the steering angle of the steering device 26. By providing the work vehicle 2 with a steering angle sensor that detects the steering angle of the steering device 26, the control device 30 may bend the course area CA and the tracking area TA based on the detection result of the steering angle sensor.

### REFERENCE SIGNS LIST

1 CONTROL SYSTEM
2 WORK VEHICLE
3 MANAGEMENT DEVICE
3A TRAVELING COURSE DATA GENERATION UNIT
3B STORAGE UNIT
3C COMMUNICATION UNIT
4 COMMUNICATION SYSTEM
5 CONTROL FACILITY
6 WIRELESS COMMUNICATION DEVICE
7 LOADER
8 CRUSHER
20 OBSTACLE SENSOR
21 TRAVELING DEVICE
22 VEHICLE BODY
23 DUMP BODY
24 DRIVE DEVICE
25 BRAKING DEVICE
26 STEERING DEVICE
27 WHEEL
27F FRONT WHEEL
27R REAR WHEEL
28 POSITION DETECTION DEVICE
29 WIRELESS COMMUNICATION DEVICE
30 CONTROL DEVICE
31 COMMUNICATION UNIT
32 TRAVELING COURSE DATA ACQUISITION UNIT
33 DETECTION DATA ACQUISITION UNIT
34 COURSE AREA SETTING UNIT
35 TRACKING AREA SETTING UNIT
36 TRACKING UNIT
37 DETERMINATION UNIT
38 TRAVELING CONTROL UNIT
39 STORAGE UNIT
AP SPECIFIC PART
CA COURSE AREA
CAf FIRST COURSE AREA
CAr SECOND COURSE AREA
CP COURSE POINT
CS TRAVELING COURSE
D DETECTION POINT
Di INTEGRATED DETECTION POINT
Dn NEW DETECTION POINT
Dr NON-TRACKING DETECTION POINT
Dt TRACKING DETECTION POINT
DPA SOIL DISCHARGING PLACE
HL TRAVELING ROAD
IS INTERSECTION
LPA LOADING PLACE
MA TRAVELING AREA
SA DETECTION AREA
SA1 LONG DETECTION AREA
SA2 SHORT DETECTION AREA
PA WORK PLACE
TA TRACKING AREA

1. A work vehicle control system comprising:
a tracking unit that tracks a detection point of an object detected by an obstacle sensor in a course area through which a work vehicle passes and a tracking area outside the course area; and
a traveling control unit that controls traveling of the work vehicle based on a tracking result of the detection point.

2. The work vehicle control system according to claim 1, wherein the tracking area is set on both sides of the course area in a vehicle width direction of the work vehicle so as to be adjacent to the course area.

3. The work vehicle control system according to claim 1, further comprising
a determination unit that determines whether or not a tracking detection point indicating the detection point tracked by the tracking unit satisfies a stop condition, wherein
when it is determined that the tracking detection point satisfies the stop condition, the traveling control unit outputs an avoidance command for avoiding a collision between the work vehicle and the object.

4. The work vehicle control system according to claim 3, wherein
the obstacle sensor irradiates the object with a detection wave, and
the stop condition includes that a reflection intensity of the detection wave from the tracking detection point existing in the course area is equal to or higher than a reflection intensity threshold.

5. The work vehicle control system according to claim 3, further comprising
a detection data acquisition unit that acquires a new detection point indicating the detection point detected by the obstacle sensor, wherein
when the tracking detection point and the new detection point satisfy an integration condition, the tracking unit tracks an integrated detection point generated by integrating the tracking detection point and the new detection point as a new tracking detection point.

6. The work vehicle control system according to claim 5, wherein the integration condition includes that a distance between the tracking detection point and the new detection point is equal to or less than a distance threshold.

7. The work vehicle control system according to claim 3, wherein the avoidance command includes at least one of a command for limiting a traveling speed of the work vehicle and a command for controlling a steering device of the work vehicle.

8. A work vehicle control method, comprising:
tracking a detection point of an object detected by an obstacle sensor in a course area through which a work vehicle passes and a tracking area outside the course area; and
controlling traveling of the work vehicle based on a tracking result of the detection point.
